(19) United States
(12) Patent Application Publication
(10) Pub. No.: US 2025/0236337 A1
(43) Pub. Date: Jul. 24, 2025

(54) VEHICLE FRONT BODY STRUCTURE

(71) Applicant: SUBARU CORPORATION, Tokyo (JP)

(72) Inventor: Naoki NISHIMURA, Tokyo (JP)

(21) Appl. No.: 18/974,159

(22) Filed: Dec. 9, 2024

(30) Foreign Application Priority Data
Jan. 24, 2024 (JP) 2024-008970

(51) Int. Cl. B62D 21/11

(52) U.S. Cl. CPC B62D 21/11

(57) ABSTRACT

A vehicle front body structure comprises a lateral pair of front side frames, a suspension cross member, a lateral pair of subframes, and a lateral pair of linkage frames. The lateral pair of front side frames extend in a longitudinal direction of a vehicle body. The suspension cross member extends in a vehicle-widthwise direction of the vehicle body below the lateral pair of front side frames and have lateral end parts coupled to middle parts of the lateral pair of front side frames. The lateral pair of subframes extend in the longitudinal direction of the vehicle body from front part of the vehicle body and have rear parts coupled to lateral end parts of the suspension cross member. The linkage frames extend in a longitudinal direction of the vehicle body and link the lateral end parts of the suspension cross member and rear parts of the front side frames.

### CROSS-REFERENCE TO RELATED APPLICATIONS

The present application claims priority from Japanese Patent Application No. 2024-008970 filed on Jan. 24, 2024, the entire contents of which are hereby incorporated by reference.

### BACKGROUND

The disclosure relates to a vehicle front body structure that comprises subframes below front side frames.

In general, the body of a vehicle such as for example an automobile utilizes the deformation (buckling) of front side frames, subframes, etc. in order to absorb an impact load applied to a bumper beam when for example a frontal collision occurs. For such vehicle bodies, there have been various proposals for a vehicle front body structure for adequately controlling a deformation mode applied to the subframes when receiving an impact load.

For example, Japanese Unexamined Patent Application Publication (JP-A) No. 2001-310755 discloses a technique in which subframes extending from the front end of the engine room to the lower surface of the floor are supported by front side frames at least at three attachment points. JP-A No. 2001-310755 discloses a subframe supporting member etc. formed on a suspension cross member, as an attachment point for supporting a subframe at a front side frame.

However, the above subframe disclosed by JP-A No. 2001-310755 is elongated such as to extend from the front end of the engine room to the lower surface of the floor. This type of elongated subframe is often subject to layout restrictions for assembling it into the vehicle body. An elongated subframe may make it difficult to adequately control deformation modes.

### SUMMARY

An aspect of the disclosure provides a vehicle front body structure comprising: a lateral pair of front side frames that extend in a longitudinal direction of a vehicle body; a suspension cross member that extends in a vehicle-widthwise direction of the vehicle body below the lateral pair of front side frames and that have lateral end parts coupled to middle parts of the lateral pair of front side frames respectively; a lateral pair of subframes that extend in the longitudinal direction of the vehicle body from a front part of the vehicle body and that have rear parts coupled to lateral end parts of the suspension cross member; and a lateral pair of linkage frames that extend in the longitudinal direction of the vehicle body and that link the lateral end parts of the suspension cross member and rear parts of the lateral pair of front side frames.

### BRIEF DESCRIPTION OF THE DRAWINGS

FIG. 1 is a perspective view schematically illustrating a vehicle front body frame of a vehicle;

FIG. 2 is a side view illustrating the vehicle front body frame of the vehicle;

FIG. 3 is a side view illustrating the vehicle front body frame of the vehicle with a front suspension arm removed;

FIG. 4 is an exploded side view of the vehicle front body frame of the vehicle with a front suspension arm removed;

FIG. 5 is a perspective view illustrating a vehicle body frame around a subframe diagonally seen from below;

FIG. 6 is a perspective view illustrating subframes and a support cross member;

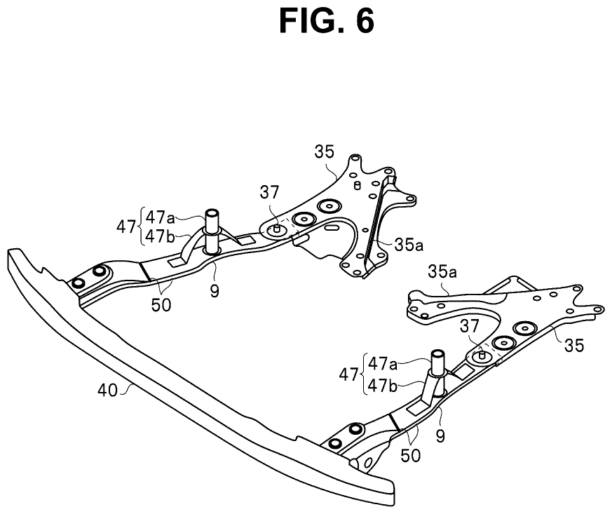

FIG. 7 is a side view illustrating the subframe; and

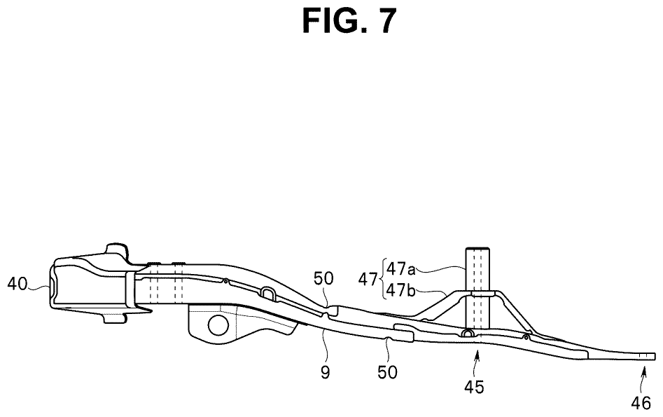

FIG. 8 is a schematic view illustrating the vehicle front body frame deformed by an impact load applied from the front of the vehicle body.

### DETAILED DESCRIPTION

It is desirable to provide a vehicle front body structure that can increase the degree of freedom for the layout of a subframe and can adequately control deformation modes of the subframe.

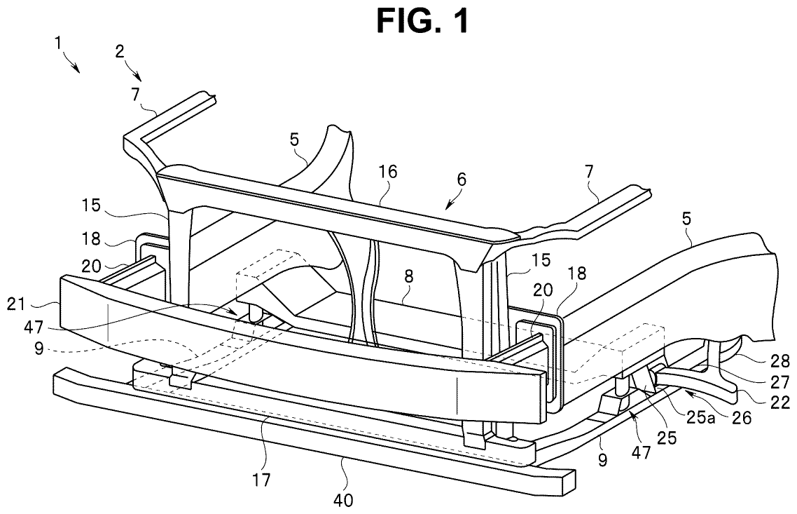

Embodiments of the disclosure will be described below with reference to the drawings. The drawings are for an embodiment of the disclosure, and FIG. 1 is a perspective view illustrating a vehicle front body frame of a vehicle.

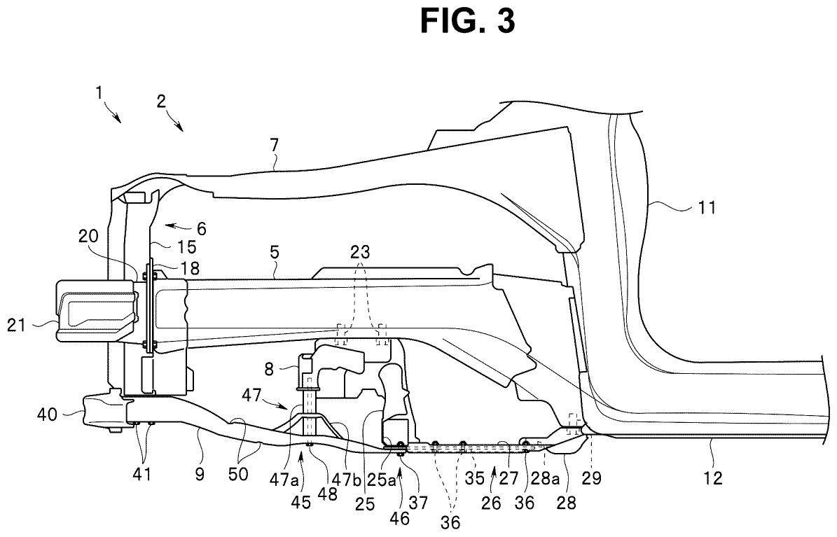

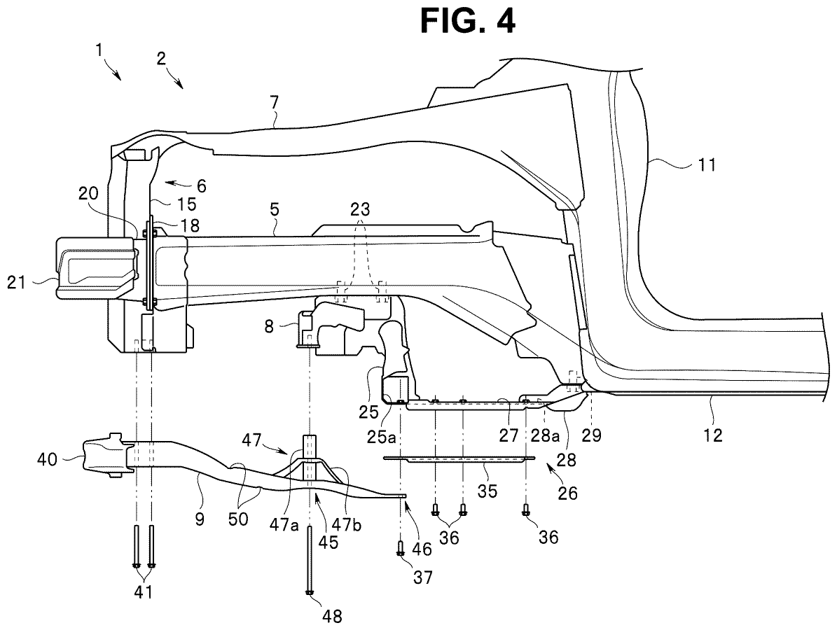

As illustrated in FIG. 1 through FIG. 4, a vehicle body 2 constituting the front part of a vehicle 1 is configured by for example assembling panel-shaped members obtained by applying press molding to steel plates.

The vehicle body 2 comprises a lateral pair of front side frames 5, a radiator support 6, a lateral pair of upper side frames 7, a suspension cross member 8, and a lateral pair of subframes 9.

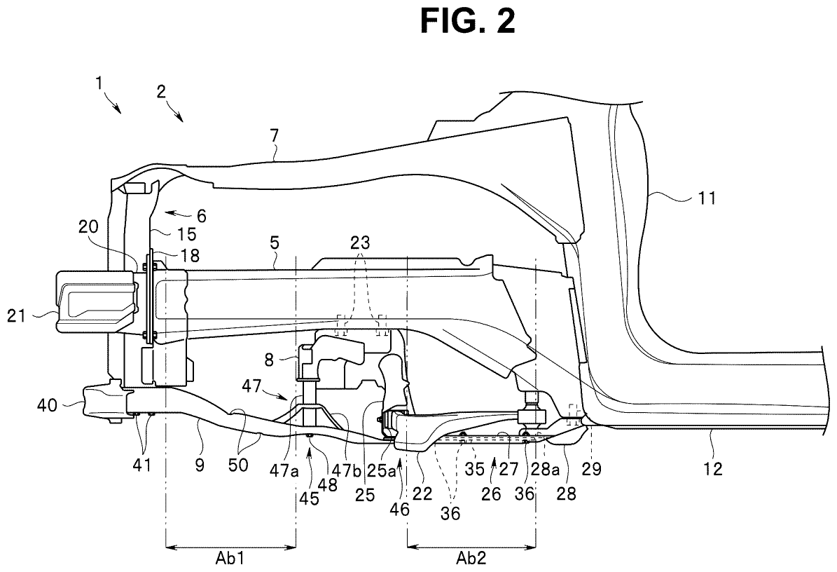

Each of the front side frames 5 extends in the longitudinal direction of the vehicle body 2. Each of the front side frames 5 has its proximal-end side downwardly becoming wider while curving toward the vehicle-widthwise outer side. Thereby, each of the front side frames 5 has its proximal end part coupled to its corresponding one of right and left front pillars 11 and to its corresponding one of right and left side sills 12 (FIG. 2 through FIG. 4).

The radiator support 6 comprises a lateral pair of radiator support sides 15, a radiator support upper 16, and a radiator support lower 17.

Each of the radiator support sides 15 has its upper end part joined to its corresponding one of the lateral end parts of the radiator support upper 16. Each of the radiator support sides 15 also has its lower end part joined to its corresponding one of the lateral end parts of the radiator support lower 17. The radiator support 6 thus has a substantially rectangular frame shape.

Also, each of the radiator support sides 15 comprises a plate-shaped frame attachment member 18 that projects toward the vehicle-widthwise outer side.

To the rear surface of each of the frame attachment members 18, the front end part of its corresponding one of the front side frames 5 is coupled through welding etc.

Also, to the front surface of each of the frame attachment members 18, the proximal end part of its corresponding one of crush boxes 20 is coupled through fastening etc. To the front end parts of these crush boxes 20, a bumper beam 21 extending in the vehicle-widthwise direction is coupled. Each of the crush boxes 20 can absorb an impact load applied to the bumper beam 21 through buckling. Each of the crush boxes 20 can further transmit, to each of the front side frames 5, an impact load that has not been absorbed through the buckling.

Each of the upper side frames 7 extends in the longitudinal direction of the vehicle body 2 above its corresponding one of the front side frames 5 and on the vehicle-widthwise outer sides. Each of the upper side frames 7 has its proximal end part coupled to its corresponding one of the right and left front pillars 11. Each of the upper side frames 7 also has its front end part coupled to its corresponding one of the lateral end parts of the radiator support upper 16 through for example welding.

Below each of the front side frames 5, the suspension cross member 8 extends in the vehicle-widthwise direction. The suspension cross member 8 has its lateral end parts rising upward. Each of these lateral end parts of the suspension cross member 8 is coupled to a point halfway on the bottom of its corresponding one of the front side frame 5. The coupling is achieved through for example fastening with bolts 23.

The suspension cross member 8 thus coupled to the front side frames 5 increases the rigidity of areas halfway on the front side frames 5. Thereby, the areas in which the suspension cross member 8 is coupled are designed to have anti-impact-load rigidity higher than that of the other areas in the longitudinal direction of the front side frames 5. In other words, each of the front side frames 5 is designed to have lower rigidity in areas on the front and rear sides with respect to the coupling area with the suspension cross member 8 than that in the coupling area. Thereby, the areas on the front and rear sides with respect to the coupling area with the suspension cross member 8 on each of the front side frames 5 are respectively designed as buckling areas Ab1 and Ab2 for an impact load.

The suspension cross member 8 also comprises a first arm supporting member 25 at a rear spot of each of its lateral end parts. Each of the first arm supporting members 25 projects downward from its corresponding one of the lateral end parts of the suspension cross member 8. Each of these first arm supporting members 25 comprises, at its projection end part, a first bearing 25a configured to support a front part of its corresponding suspension arm 22.

Each of the first arm supporting members 25 also has a linkage member 27 linked to its projection end part. Each of the linkage members 27 is constituted of, for example, a sheet metal member projecting toward the rear of the vehicle body 2 from the projection end part of its corresponding one of the first arm supporting members 25. Each of the linkage members 27 comprises a second arm supporting member 28 at its projection end part.

Each of the second arm supporting members 28 is fastened to a rear part of its corresponding one of the front side frames 5 by for example using a bolt 29. Also, each of the second arm supporting members 28 comprises a second bearing 28a configured to support a rear part of its corresponding one of the suspension arms 22. In the present embodiment, each of the second bearings 28a supports a rear part of its corresponding one of the suspension arms 22 between the second bearing 28a itself and its corresponding one of the front side frames 5.

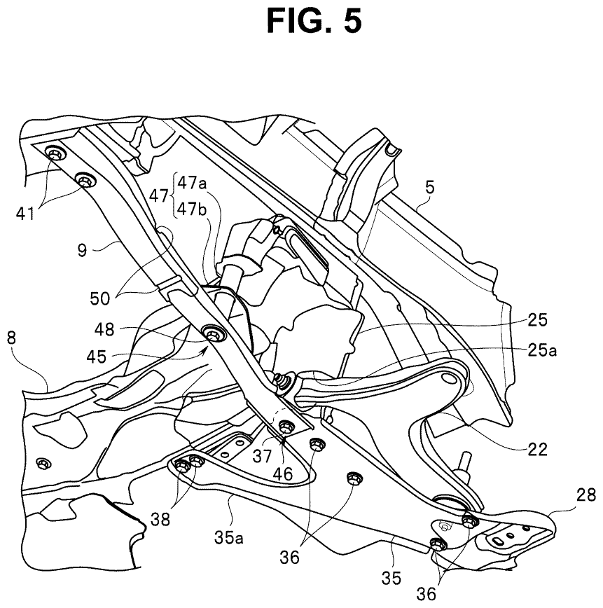

Each of thus configured linkage members 27 has a support cross member 35 attached to its bottom (see FIG. 5). Each of the support cross members 35 is constituted of, for example, a sheet metal member extending in the longitudinal direction of the vehicle body 2 along the bottom of its corresponding one of the linkage members 27. In the present embodiment, each of the support cross members 35 constitutes its corresponding one of the linkage frames 26 together with its corresponding one of the linkage members 27. For this purpose, each of the support cross members 35 is fastened at its spots to its corresponding one of the linkage members 27 by for example using bolts 36.

Each of the support cross members 35 has its tip projecting to the position at which the tip part faces the bottom of its corresponding one of the first arm supporting members 25. The tip part of each of the support cross members 35 is fastened to the bottom of its corresponding one of the first arm supporting members 25 by for example using a bolt 37.

Each of thus configured linkage frames 26 links together its corresponding one of the lateral end parts of the suspension cross member 8 and a rear part of its corresponding one of the front side frames 5. Each of the linkage frames 26 is disposed at a longitudinal position substantially corresponding to a buckling area Ab2 of its corresponding one of the front side frames 5. The linkage frames 26 are designed to have lower rigidity than that of the suspension cross member 8. This causes the linkage frames 26 to buckle more easily than the suspension cross member 8 when an impact load is applied from the front of the vehicle body 2.

As illustrated in for example FIG. 5, each of the support cross members 35 has a Y-shaped branching portion 35a directed to the vehicle-widthwise inner side. Each of the branching portions 35a has its end parts fastened to points halfway on the suspension cross member 8 by for example using bolts 38.

As illustrated in FIG. 2 through FIG. 4, each of the subframes 9 extends for example in the longitudinal direction of the vehicle body 2 in an area ranging from a front part of the vehicle body 2 to the vicinity of the rear end of the suspension cross member 8.

The subframes 9 have a sub bumper beam 40 coupled to their front ends through for example welding. The sub bumper beam 40 extends in the vehicle-widthwise direction. On the rear side with respect to the sub bumper beam 40, the subframes 9 have their front parts fastened to the radiator support lower 17 by for example using bolts 41.

Each of the subframes 9 also has its rear part coupled to its corresponding one of the lateral end parts of the suspension cross member 8. In the present embodiment, each of the subframes 9 has a first coupling part 45 and a second coupling part 46 as coupling parts to the suspension cross member 8.

Each of the first coupling parts 45 couples its corresponding subframe 9 to a front part of its corresponding one of the lateral end parts of the suspension cross member 8. In other words, the first coupling parts 45 couple the subframes 9 to the suspension cross member 8 on the front side with respect to the first arm supporting members 25. Thus, the first coupling parts 45 comprise brackets 47 in a gap between the subframes 9 and the suspension cross member 8.

The bracket 47 comprises for example a bolt-insertion tube 47a. This bolt-insertion tube 47a has for example a cylindrical shape The bolt-insertion tube 47a is fixed through welding etc. to the subframe 9 while piercing through the subframe 9 in the up and down direction. Further, the bolt-insertion tube 47a projects upward up to a position at which it abuts on the bottom of the suspension cross member 8.

On the upper side with respect to the subframe 9, a leg 47b is coupled to a position halfway on the bolt-insertion tube 47a. The leg 47b is constituted of for example a sheet metal member having a substantially hat-like shape in a side view. This leg 47b increases the rigidity of the bolt-insertion tube 47a. For this purpose, the 47b has its top part coupled to the bolt-insertion tube 47a through welding etc. The leg 47b also has its front and rear end parts coupled to the upper surface of the subframe 9 through welding etc.

Through the bolt-insertion tubes 47a of each of thus configured brackets 47, a bolt 48 is inserted. The bolt 48 inserted through each of the bolt-insertion tubes 47a is fastened to the suspension cross member 8. Thereby, each of the brackets 47 couples its corresponding one of the subframes 9 to the suspension cross member 8.

Each of the second coupling parts 46 couples its corresponding one of the subframes 9 to a rear part of its corresponding one of the lateral end parts of the suspension cross member 8. In other words, the second coupling parts 46 couple the subframes 9 to the suspension cross member 8 at positions corresponding to the first arm supporting members 25. For this purpose, the second coupling parts 46 have bolt insertion holes at positions corresponding to the fastening parts at which the first arm supporting members 25 and the support cross members 35 are fastened. The subframes 9 are coupled to the first arm supporting members 25 (suspension cross member 8) at the second coupling parts 46 through joint fastening with the support cross members 35 by using the bolts 37.

The subframes 9 are designed to have lower rigidity than that of the suspension cross member 8. This causes the area on the front side with respect to the first coupling part 45 on each of the subframes 9 to buckle more easily than the suspension cross member 8 when an impact load is applied from the front of the vehicle body 2. In other words, an area on each of the subframes 9 that substantially corresponds to the buckling area Ab1 of its corresponding one of the front side frames 5 is designed as an area that buckles more easily than the suspension cross member 8.

In some embodiments, this configuration comprises a bead 50 at a desirable point of each of the subframes 9 in order to adequately control the buckling mode of the subframe 9.

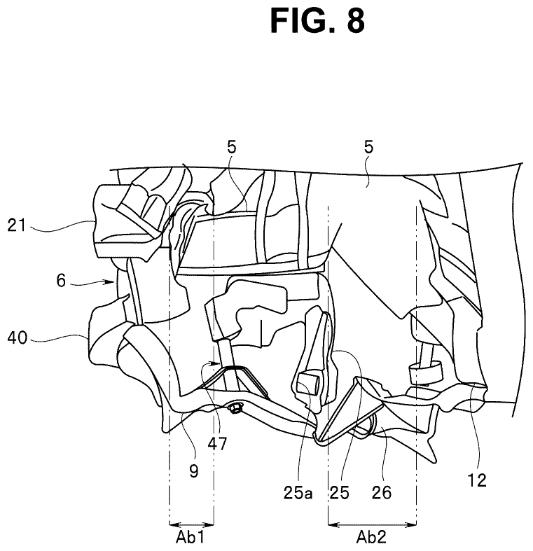

In thus configured vehicle body 2, the front side frames 5 buckle mainly at the buckling areas Ab1 and Ab2 as illustrated in FIG. 8 when an impact load is applied by for example a frontal collision to the bumper beam 21, the sub bumper beam 40, etc.

Also, below the front side frames 5, each of the subframes 9 buckles in the area corresponding to its corresponding buckling area Ab1. Further, below the front side frames 5, each of the linkage frames 26 buckles in the area corresponding to its corresponding buckling area Ab2.

As described above, the subframes 9 and the linkage frames 26 buckle in the areas (buckling areas Ab1 and Ab2) corresponding to the areas in which their corresponding front side frames 5 buckle in the longitudinal direction of the vehicle body 2.

As described above, a vehicle front body structure according to the present embodiment comprises a lateral pair of front side frames 5 that extend in a longitudinal direction of a vehicle body 2; a suspension cross member 8 that extends in a vehicle-widthwise direction below the lateral pair of front side frames 5 and that have lateral end parts coupled to spots halfway on the lateral pair of front side frames 5; a lateral pair of subframes 9 that extend in a longitudinal direction of the vehicle body 2 and that have rear parts coupled to lateral end parts of the suspension cross member 8; and a lateral pair of linkage frames 26 that extend in a longitudinal direction of the vehicle body 2 and that link the lateral end parts of the suspension cross member 8 and rear parts of the lateral pair of front side frames 5.

It is thereby possible to increase the degree of freedom for the layout of the subframes 9 and to adequately control deformation modes of the subframes 9.

Specifically, each of the subframes 9 is designed to have a length such that the subframe 9 extends in the longitudinal direction of the vehicle body 2 over an area ranging from a front part of the vehicle body 2 to the vicinity of the rear end of the suspension cross member 8. This can remarkably increase the degree of freedom for assembling the subframes 9 into the vehicle body 2, relative to when the subframes 9 projects up to the position at which the subframes 9 are coupled to the rear parts of the front side frames 5. This also enables the subframes 9 to be designed to have a small length, thereby to adequately control deformation modes against an impact load.

Also, even when the subframes 9 are designed to have a small length, the lateral end parts of the suspension cross member 8 and the rear parts of the front side frames 5 are linked together by the use of the lateral pair of the linkage frames 26. Thereby, an impact load applied to the sub bumper beam 40 can be absorbed adequately also on the rear side with respect to the suspension cross member 8.

In that case, the subframes 9 have their rear parts fixed to the suspension cross member 8 through fastening via the brackets 47. This enables the subframes 9 to be securely fixed to the suspension cross member 8 even when gaps exist between the rear parts of the subframes 9 and the suspension cross member 8.

Also, the subframes 9 have their rear parts coupled to the suspension cross member 8 through joint fastening with the support cross members 35, which constitute the linkage frames 26. This enables a load to appropriately be transmitted from each of the subframes 9 to its corresponding one of the linkage frames 26 while adequately controlling deformation modes of the subframes 9 with their smaller length.

Further, the subframes 9 have the beads 50 at spots halfway on the subframes 9 in the longitudinal direction of the vehicle body 2. Providing the subframes 9 with these beads 50 sets starting points for buckling on the subframes 9, thereby enabling more adequate control of deformation modes of the subframes 9.

The disclosure described in the above embodiments is not limited to the embodiments, and various modifications can be made within a scope not departing from the spirit of the disclosure when implementing the disclosure. Further, the above embodiments encompass disclosure at various stages, and various disclosure can be extracted from appropriate combinations of the disclosed constituents.

For example, when the above stated problem can be solved and the above stated effect can be achieved even if some constituents are omitted from among all the constituents disclosed in the above embodiments, a configuration resulting from such omission of the constituents can be extracted as disclosure.

According to a vehicle front body structure of the embodiments of the disclosure, it is possible to increase the degree of freedom for the layout of a subframe and to adequately control deformation modes of the subframe.

1. A vehicle front body structure comprising:
a lateral pair of front side frames that extend in a longitudinal direction of a vehicle body;
a suspension cross member that extends in a vehicle-widthwise direction of the vehicle body below the lateral pair of front side frames and that have lateral end parts coupled to middle parts of the lateral pair of front side frames respectively;
a lateral pair of subframes that extend in the longitudinal direction of the vehicle body from a front part of the vehicle body and that have rear parts coupled to lateral end parts of the suspension cross member; and
a lateral pair of linkage frames that extend in the longitudinal direction of the vehicle body and that link the lateral end parts of the suspension cross member and rear parts of the lateral pair of front side frames.

2. The vehicle front body structure according to claim 1, wherein
each of the lateral pair of subframes comprises a first coupling part coupled to a front part of corresponding one of the lateral end parts of the suspension cross member, and
the first coupling parts are fixed to the suspension cross member through fastening via brackets.

3. The vehicle front body structure according to claim 1, wherein
each of the lateral pair of subframes comprises a second coupling part coupled to a rear part of corresponding one of the lateral end parts of the suspension cross member, and
the second coupling parts are coupled to the suspension cross member through joint fastening with a constituent of the linkage frames.

4. The vehicle front body structure according to claim 1, wherein
at least one of the pair of subframes has a middle part with a bead in the longitudinal direction of the vehicle body.
